(19) United States
(12) Patent Application Publication
(10) Pub. No.: US 2025/0355951 A1
(43) Pub. Date: Nov. 20, 2025

(54) MULTIFACETED REFORMULATIONS FOR NULL AND LOW QUERIES

(71) Applicant: eBay Inc., San Jose, CA (US)

(72) Inventors: Jayanth Kumar YETUKURI, San Jose, CA (US); Yuyan WANG, Milpitas, CA (US); Ishita Kamal KHAN, San Jose, CA (US); Liyang HAO, San Jose, CA (US); Zhe Wu, Mountain View, CA (US)

(21) Appl. No.: 18/999,873

(22) Filed: Dec. 23, 2024

Related U.S. Application Data
(60) Provisional application No. 63/648,583, filed on May 16, 2024.

(51) Int. Cl. G06F 16/9532

(52) U.S. Cl. CPC G06F 16/9532

(57) ABSTRACT

A search engine leverages a neural translation model to provide diverse and multiple query reformulations. Two decoders are injected and a diversity inducing optimization function is introduced. After a query input is received from a user, a number of items are retrieved from a database in response to the query input. In response to a determination the query input is a null and low query based on a number of responsive items, a plurality of decoders is injected and a diversity inducing optimization function is leveraged to generate a plurality of diverse reformulated queries. A plurality of query results corresponding to the plurality of diverse reformulated queries is provided as output.

### CROSS REFERENCE TO RELATED APPLICATION

This application claims the benefit of a U.S. Provisional Application No. 63/648,583, filed on May 16, 2024, and entitled “MULTIFACETED REFORMULATIONS FOR NULL & LOW QUERIES AND ITS PARALLELISM WITH COUNTERFACTUALS,” which is hereby incorporated herein by reference in its entirety.

### BACKGROUND

Search engines are crucial in retrieving relevant items based on user-specified queries. A significant challenge arises when the vocabulary of a user performing a search does not align with the vocabulary of a particular item that may be relevant to the search, resulting in a lack of sufficient recall or unsatisfactory results. These search queries may be referred to as null and low queries which can hinder the overall user experience. Moreover, actual analysis of user search behavioral data has revealed approximately twenty-nine percent of search queries exhibit multiple category interpretations, which may be referred to as multifaceted query interpretations. In the context of e-commerce, the experience of a potential buyer can lead to abandonment.

### SUMMARY

At a high level, aspects described herein relate to search engines. More particularly, aspects described herein relate to a search engine that leverages a neural translation model to provide diverse and multiple query reformulations. To do so, two decoders are injected and a diversity inducing optimization function is introduced. Initially, a query input is received from a user. A number of items are retrieved from a database in response to the query input. In response to a determination the query input is a null and low query based on a number of responsive items, a plurality of decoders is injected and a diversity inducing optimization function is leveraged to generate a plurality of diverse reformulated queries. A plurality of query results corresponding to the plurality of diverse reformulated queries is provided as output.

The Summary is intended to introduce a selection of concepts in a simplified form that is further described in the Detailed Description of this disclosure. The Summary is not intended to identify key or essential features of the claimed subject matter, nor is it intended to be used as an aid in determining the scope of the claimed subject matter. Additional objects, advantages, and novel features of the technology will be provided, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 is a block diagram of an example operating environment suitable for implementing aspects of the technology;

FIG. 2 is an example system diagram, in accordance with an aspect of the technology described herein;

FIG. 3 is a flow diagram showing an example method, in accordance with an aspect of the technology described herein; and

FIG. 4 is an example computing device suitable for implementing the described technology, in accordance with an aspect described herein.

### DETAILED DESCRIPTION

The subject matter of aspects of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

While search engines are an incredibly useful tool for providing search results for received search queries, shortcomings in existing search technologies often result in the consumption of an unnecessary quantity of computing resources (e.g., I/O costs, network packet generation costs, throughput, memory consumption, etc.). When performing searches, buyers may not utilize the same vocabulary as the sellers. If the seller lists an item utilizing different terms than the buyer, current search engines may suffer from a lack of sufficient recall or may simply provide unsatisfactory results.

The performance of search engines is typically measured by several business metrics including purchases and click-through rate. Other metrics may include precision and recall. Precision measures how many retrieved items were relevant and recall measures how many relevant items were retrieved. For a particular search, if there is a vocabulary gap between a buyer and sellers, the search may not accurately capture the intent of the buyer, making retrieval difficult. Retrieval by a search engine often employs a complex combination of machine learning models and human-defined rules intended to return a list of items that best interprets the user query. Approximately twenty-five percent of queries result in either a zero- or low-relevant inventory set in the search results (i.e., null and low queries).

This requires the user to perform multiple searches which unnecessarily consumes various computing resources of the search system, such as processing power, network bandwidth, throughput, memory consumption, etc. In some instances, the multiple attempts to identify items may even completely fail to satisfy the user's goal, thus requiring the user to spend even more time and computing resources on the search process by repeating the process of issuing additional queries until the user finally accesses the desired content items. In some cases, the user may even give up searching because the search engine was not able to return desired search results after multiple searches.

These shortcomings of existing search technologies adversely affect computer network communications. For example, each time a query is received, contents or payload of the search queries is typically supplemented with header information or other metadata, which is multiplied by all the additional queries needed to obtain the particular item(s) the user desires. As such, there are throughput and latency costs by repetitively generating this metadata and sending it over a computer network. In some instances, these repetitive inputs (e.g., repetitive clicks, selections, or queries) increase storage device I/O (e.g., excess physical read/write head movements on non-volatile disk) because each time a user inputs unnecessary information, such as inputting several queries, the computing system often has to reach out to the storage device to perform a read or write operation, which is time consuming, error prone, and can eventually wear on components, such as a read/write head. Further, if multiple users repetitively issue queries, it is expensive because processing queries consumes a lot of computing resources. For example, for some search engines, a query execution plan may need to be calculated each time a query is issued, which requires a search system to find the least expensive query execution plan to fully execute the query. This decreases throughput and increases network latency, and can waste valuable time.

Conventional baseline null and low query recovery systems utilize a heuristic recovery model, which matches an empirically determined fraction of query tokens (terms corresponding to one or more portions of the query) with catalog item titles. The rest of the query tokens are dropped by these systems since matching all the query tokens provided an insufficient recall set (i.e., the set of items retrieved). This technique may result in an improved recall set; however it compromises precision for the query-item relevance.

For example, a null and low query for “old flower decoration tea pot set” might retrieve items that match any two tokens with the catalog item titles irrespective of the linguistic signals, which may fail to understand the intent of the query (in this case, “tea pot set”). In this regard, multiple category interpretations can typically be identified in a significant portion of search queries in historical search queries. Accordingly, deriving multiple reformations for a query may retrieve additional relevant recall which can be beneficial when the original query is null and low. In experiments, approximately twenty-nine percent of user-issued reformulations (of the same source query, by the same user, in the same session) belong to different item categories. For example, “womens gothic clothing” can be interpreted as both “womens gothic dresses” and “womens gothic skirts,” the items of which belong to different categories.

At a high level, aspects of the technology described herein automatically provide multiple alternative reformulations to enhance relevant recall for null and low queries, while ensuring the reformulations are diverse to enhance user engagement. By formulating the null and low query reformulation problem into an NMT based framework, designing a sequence-to-sequence model, and introducing a diversity-inducing optimization function, experiments reveal a ten percent improvement in the F1 score, an average five percent improvement in relevance, and a one hundred percent recall set size improvement over a heuristic baseline for a set of null and low queries. As described herein, these improvements improve the functioning of the computer itself, provide a number of improvements over existing search technologies, and improve storage device or disk I/O and query execution functionality.

Aspects of the technology described herein improve the functioning of the computer itself in light of these shortcomings in existing search technologies by providing a solution that leverages a neural translation model (NMT) to provide diverse and multiple query reformulations. Experiments have shown the neural translation model achieves ten percent F-score improvement on a test dataset with a five percent improvement in relevance and a one hundred percent increase in recall set size compared to a heuristic baseline (specifically for a set of null and low queries sampled from user traffic). As can be appreciated, better results are achieved compared to traditional search engines that do not provide diverse and multiple query reformulations and/or require multiple search queries from the user.

Aspects of the technology described herein provide a number of improvements over existing search technologies. For instance, computing resource consumption is improved relative to existing technologies. In particular, the search frequency is reduced by providing diverse and multiple query reformulations. This eliminates (or at least reduces) the repetitive user queries because the user is able to access the desired content items in less searches. Accordingly, aspects of the technology described herein decrease computing resource consumption, such as processing power and network bandwidth.

In like manner, aspects of the technology described herein improve storage device or disk I/O and query execution functionality. As described above, the diverse and multiple query reformulations result in less searches and accordingly, less reads of the database when an item a user searches for an item. In contrast, current search technologies suffer from a lack of sufficient recall or unsatisfactory results. This is much less efficient for disk I/O because the database is queried multiple times. Accordingly, there is not as much wear due to query execution functionality.

Having briefly described an overview of aspects of the technology described herein, an exemplary operating environment in which aspects of the technology described herein may be implemented is described below.

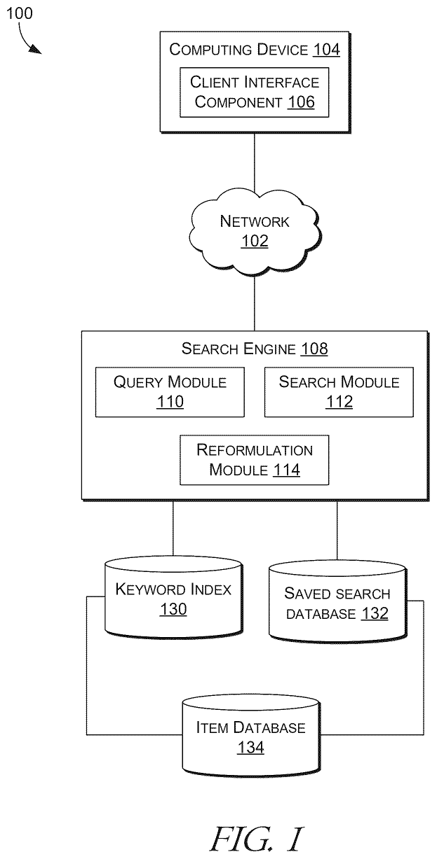

Turning now to FIG. 1, a block diagram is provided showing an operating environment 100 in which aspects of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

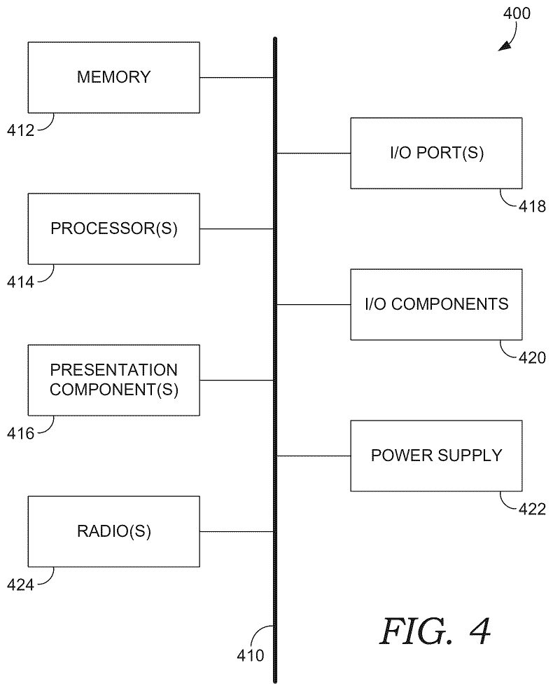

Among other components not shown, example operating environment 100 includes a network 102; a computing device 104 having a client interface component 106; search engine 108 having a query module 110, a search module 112, and a reformulation module 114; keyword index 130; saved search database; and item database 134. It should be understood that environment 100 shown in FIG. 1 is an example of one suitable operating environment. Each of the components shown in FIG. 1 may be implemented via any type of computing device, such as computing device 400, described below in connection to FIG. 4, for example.

These components may communicate with each other via the network 102, which may include, without limitation, one or more local area networks (LANs) and/or wide area networks (WANs). In exemplary implementations, the network 102 comprises the Internet and/or a cellular network, amongst any of a variety of possible public and/or private networks. In aspects, the network 102 may include multiple networks, as well as being a network of networks, but is shown in more simple form to not obscure other aspects of the present disclosure.

It should be understood that any number of user devices, servers, and data sources may be employed within the operating environment 100 within the scope of the present disclosure. Each may comprise a single device or multiple devices cooperating in a distributed environment. For instance, the search engine 108 may be provided via multiple devices arranged in a distributed environment that collectively provide the functionality described herein. Additionally, other components not shown may also be included within the distributed environment.

The computing device 104 can be a client device on the client-side of the operating environment 100, while the search engine 108 can be on the server-side of operating environment 100. For example, the search engine 108 can comprise server-side software designed to work in conjunction with client-side software on the computing device 104 so as to implement any combination of the features and functionalities discussed in the present disclosure. This division of the operating environment 100 is provided to illustrate one example of a suitable environment, and there is no requirement for each implementation that any combination of the search engine 108 and the computing device 104 remain as separate entities. While the operating environment 100 illustrates a configuration in a networked environment with a separate computing device, search engine, keyword index, and item database, it should be understood that other configurations can be employed in which components are combined. For instance, in some configurations, a computing device may also serve as a data source and/or may provide search capabilities.

The computing device 104 may comprise any type of computing device capable of use by a user. For example, in one aspect, the computing device 104 may be the type of computing device 400 described in relation to FIG. 4 herein. By way of example and not limitation, a computing device may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where search queries may be performed via the client interface component 106 or where notifications can be presented via the client interface component 106. A user may be associated with the computing device 104. The user may communicate with the search engine 108 through one or more computing devices, such as the computing device 104.

At a high level, the search engine 108 receives a text-based search query (e.g., a natural language query or structured query) or an audio query comprising voice or other audio input from the computing device 104 (or another computing device not depicted). In aspects, the text-based query or the audio query comprises one or more keywords. The search query may comprise any type of input from a user for initiating a search comprising one or more keywords. In response to receiving the search query, the search engine 108 generates and ranks text-based results in a single set of search results.

In some configurations, the search engine 108 may be embodied on one or more servers. In other configurations, the search engine 108 may be implemented at least partially or entirely on a user device, such as computing device 400 described in FIG. 4. The search engine 108 (and its components) may be embodied as a set of compiled computer instructions or functions, program modules, computer software services, or an arrangement of processes carried out on one or more computer systems.

As shown in FIG. 1, the search engine 108 includes the query module 110, the search module 112, and a reformulation module 114. In one aspect, the functions performed by modules of the search engine 108 are associated with one or more applications, services, or routines. In particular, such applications, services, or routines may operate on one or more user devices (such as computing device 104) or servers (e.g., the search engine 108), or may be distributed across one or more user devices and servers. In some aspects, the applications, services, or routines may be implemented in the cloud. Moreover, in some aspects, these modules of the search engine 108 may be distributed across a network, including one or more servers and client devices (such as computing device 104), in the cloud, or may reside on a user device such as computing device 104.

In addition, the modules of the search engine 108 and the functions and services performed by these modules may be implemented at appropriate abstraction layer(s) such as an operating system layer, an application layer, or a hardware layer, etc. Alternatively, or in addition, the functionality of these modules (or the aspects of the technology described herein) can be performed, at least in part, by one or more hardware logic components. For instance, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Further, although functionality is described herein with regards to specific modules shown in search engine 108, it is contemplated that in some aspects, functionality of one of the modules can be shared or distributed across other modules.

The query module 110 receives a search query comprising one or more text-based keywords. For example, a user may input a search query at computing device 104 via a client interface component 106 that provides access to a search engine. As previously mentioned, the search query may comprise any type of input from a user for initiating a search comprising one or more keywords.

The query module 110 may be configured to receive the search. Additionally, the query module 110 may be configured to communicate the search query to other modules of search engine 108, such as the search module 112 or reformulation 114, for example. Further, the user query module 110 may be configured to suggest and provide refinements of a search query, generate and provide navigation modules, categorize or categorize the plurality of items, generate and provide autosuggestions, generate reformulations of the search query, or provide search results to computing devices, such as computing device 104.

The query module 110 may cause one or more graphical user interface displays of various computing devices to display the search query, suggested refinements to the search query, navigation modules, categories of items responsive to the search query, autosuggestions, reformulations, or items responsive to the search query. In aspects, query module 110 causes the client interface component 106, through which the search query is input (e.g., by a user in a search tool on a web page), to display the search query, suggested refinements, navigation modules, categories of items responsive to the search query, autosuggestions, reformulations, or items responsive to the search query. Further, the query module 110 may comprise an Application Program Interface (API) that allows applications to submit the search query (and optionally other information, such as user information, contextual information, and the like) for receipt by the search engine 108.

The search module 112 identifies search results in response to search queries processed against item database 134, which is described in more detail below. For example, the search module 112 may query the keyword index 130 to identify results that satisfy criteria of the search query. In some aspects, the results identified in the keyword index 130 are mapped to items in the item database 134. For clarity, an item may be an item listing for a product and may include a variety of additional information, such as price, price range, quality, condition, ranking, material, brand, manufacturer, etc.

The search module 112 also ranks the search results. In some aspects, information learned from historical search sessions or user feedback is utilized to optimize the ranking of the search results. For example, selections made by other users submitting similar queries may be leveraged to increase or decrease the ranking of individual items within the search results.

In some aspects, feedback may be stored in search logs. The search logs may be embodied on a plurality of databases, wherein one or more of the databases comprise one or more hardware components that are part of the search engine 108. In aspects, the search log are configured for storing information regarding historical search sessions for users, including, for instance, search queries submitted by a plurality of users via client interface components (e.g., client interface component 106), search results associated with the historical search queries, item listings for the search results, or user interactions (e.g., hovers, click-throughs, purchases, etc.) associated with the search results. In some embodiments, the search logs store a timestamp (e.g., day, hour, minute, second, etc.) for each user query, search result, item listing associated with the search result, user interaction with the search result, and so forth.

In addition, the information stored in search logs regarding historical search sessions may include other result selection information, such as subsequent filters selected in response to receiving search results and item listings, or user reformulations. In some embodiments, result selection information may include the time between two successive selections of search results, the language employed by the user, and the country where the user is likely located (e.g., based on a server used to access the search engine 108). In some implementations, other information associated with the historical search sessions that is stored may comprise user interactions with a ranking displayed within an item listing, negative feedback displayed with the item listing, and other information such as whether the user clicked or viewed a document associated with an item listing. User information including user cookies, cookie age, IP (Internet Protocol) address, user agent of the browser, and so forth, may also be stored in search logs. In some embodiments, the user information is recorded in the search logs for an entire user session or multiple user sessions.

The keyword index 130, saved search database 132, and item database 134 may comprise data sources or data systems, which are configured to make data available to any of the various constituents of operating environment 100. The keyword index 130, saved search database 132, and item database 134 may be discrete components separate from search engine 108 or may be incorporated or integrated into the search engine 108 or other components the operating environment 100. Among other things, item database 134 can store search results associated with search queries about which information can be indexed in keyword index 130. Moreover, item database 134 can store search results associated with users and categories which are associated in a hierarchical data structure in saved search database 132.

The keyword index 130 can take the form of an inverted index, but other forms are possible. The keyword index 130 stores the information about items in a manner that allows the search engine 108 to efficiently identify search results for a search query. The search engine 108 can be configured to run any number of queries on the keyword index 130. The keyword index 130, according to an example embodiment, may include an inverted index storing a mapping from textual search queries to items in item database 134.

The saved search database 132 can take the form of a hierarchical data structure, but other forms are possible. The saved search database 132 stores information about saved searches (i.e., associations between users and categories or users and sellers) that allows the search engine 108 to efficiently, and in real-time, identify search results for a saved search query when a relevant item is listed by a buyer in item database 134. The search engine 108 can be configured to run any number of queries, in real-time, on the saved search database 132. The saved search database 132, according to an example embodiment, may include a hierarchical data structure storing a mapping between users and categories or users and sellers to items in item database 134.

The reformulation module 114 leverages a neural translation model to provide diverse and multiple query reformulations. As described herein, the reformulation module 114 injects two decoders in a sequence-to-sequence model and a utilizes a diversity inducing optimization function. In practice, a query input is received from a user. A number of items are retrieved from a database in response to the query input. In response to a determination the query input is a null and low query based on a number of responsive items, a plurality of decoders is injected to sequence-to-sequence model and a diversity inducing optimization function is leveraged to generate a plurality of diverse reformulated queries. A plurality of query results corresponding to the plurality of diverse reformulated queries is provided as output.

In practice, a search engine (SE) receives a user query q and retrieves relevant items from database. With a fixed item index space and retrieval mechanism, q is identified as a null and low query if the number of items retrieved for q is less than a threshold T. Assume for SE(q), {i₁, i₂, . . . , iₙ_{_{q}}} is the set of retrieved items and f is a classifier that identifies if q is a null and low query or not such that: f(SE(q))=1 if n_{q}<τ and 0 otherwise. If f(SE(q))=1, a query reformulation procedure is triggered for q to retrieve items from a reformulated query r with minimum user intent disparity.

Now assume intentDisparity (q₁, q₂) mimics user intent disparity between any two queries q₁, q₂ and Γ(q) is the set of all plausible reformulations for q. Plausibility refers to acceptable reformulation behavior such as term dropping or replacement. Referring back to conventional systems, traditional null and low query reformulation aims to identify r with minimum intent disparity for the user specified query q. A conservative solution is to recursively obtain r by dropping tokens from q until n_{q}≥τ, or until a pre-determined fraction of tokens have been dropped. However, this approach is impractical since it might lose semantic meanings of the original query. Alternatively, a deep-learning model can be trained to learn a user-intent driven behavior. Each of these models lack the capability of capturing the prevailing ambiguity in null and low user query interpretations.

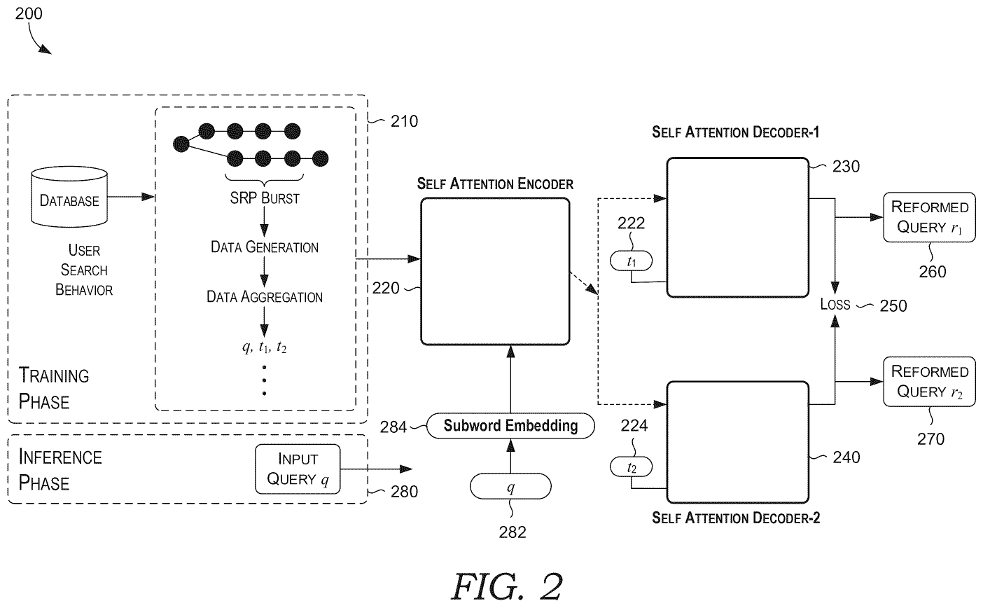

Referring back to FIG. 2, system 200 addresses such ambiguities and improves user search experience for a null and low query by diversifying the items retrieved. In this way, a deep-learning-based model is trained to obtain (at least) two diverse reformulations by solving the following optimization:

$$arg {min}_{\{ r 1 , r 2 \}} {\sum }_{i ∈ \{ 1 , 2 \}} intentDisparity ( ri , q ) ( feasibility )$$

$$s . t . f ( r 1 ) = 0 , f ( r 2 ) = 0 ( validity )$$

$$r 1 , r 2 ∈ Γ ( q ) ( plausibility )$$

$${λ}_{r 1 , r 2} \geq λ * ( diversity )$$

where λ_{r1,r2} is the diversity score between two reformulations r1 and r2. Here, λ* is the pre-determined threshold representing a minimum required diversity score.

In some aspects, counterfactual generation identifies an instance closer to the data point, which can alter the model's behavior. Consider a classification-based model g(x) which classifies an instance x to belong to class C₁. This can be solved to identify a counterfactual x′ which belongs to class C₂≠C₁ for x using the optimization: argmin_{x′}, dist(x, x′) s.t. g(x′)=C₂.

In aspects, if real-world implications of the model's decision adversely affect an instance, actionable recourse provides the desired outcome from the model. In this way, user intent can be captured for a null and low query and provide a reformulation. The feasibility of a reformulated query is determined by its closeness to the source query. The higher the similarity of r with q, the higher the feasibility of r.

In aspects, a counterfactual flips the model prediction from its prediction of the original instance. The reformulation for a null and low query can be similarly aimed at improving the relevant recall set size to be at least τ. A valid reformulation improves the user experience of a null and low query by increasing the relevant recall set size. A counterfactual may be highly plausible with respect to the training data. For clarity, plausibility can be interpreted as the acceptable reformulation behavior. Examples of such behaviors are term dropping, synonym replacement, or misspelling correction. Given the randomness of counterfactual generation techniques, a wide range of diverse counterfactuals are possible for a given instance. A similar observation of diverse user query interpretation may be observed between multiple user reformulations for the same query.

During training of the model, user behavioral data is retrieved from historical search reformulations with improved user engagement. For example, six weeks of search logs may be extracted and three different versions of datasets may be constructed based on the reformulation behavior with the following steps. First, in some aspects, a user enters a search query q, then reformulates it to a reformulated query t₁ and reformulates it again if necessary. Now, assume a user session lasts approximately ten minutes and all the search information in that session is consolidated into an SRP burst. Each SRP burst signifies a sequence of successful user query transitions/reformulations along with user engagement signals. In some aspects, only 2 hop pairs are sampled.

Second, in some aspects, each consecutive hop-1 and hop-2 reformulations are considered to be one neighbor and two neighbors (away) from the source query. For a user query q, let the corresponding user-reformulated targets be t₁ and t₂. Acceptability of t₁ and t₂ may be established by an increase in user engagement, measured by a user engagement score, ueScore(q) for q. Successful user engagement is used as an approximation for ground truth. A typical ueScore(⋅) may be a linear combination of multiple signals like user clicks, active time spent, and actions like add to cart. A valid user query transition shows a minimum increase of 10% (established by a domain expert).

For simplicity, both t₁ and t₂ are considered to be conditionally independent. This is due to the fact that both the targets are derived (with some minor modification) from the same source query q. Here, a user can go to either of the targets from q, implying that t₁ is not an intermediate query.

Third, in some aspects, each filtered dataset versions has a specific user reformulation behavior. User profiles are not accounted for, meaning each data point is independent of the other. A term drop (TD) strategy is a highly conservative version of reformulation behavior where reformulations can only drop tokens. Additionally, for the purpose of capturing diversity, the two reformulations are not identical. Since most null and low queries are over-specified, term dropping may significantly improve the relevant recall performance.

Additionally or alternatively, a term drop constrained replace (TDCR) strategy represents a slightly conservative version of reformulation behavior where reformulations can drop and replace tokens in the source query. Constrained replace refers to datasets that only allow replacements that do not increase the length of the source query.

Additionally or alternatively, a term drop reform (TDR) strategy represents a highly aggressive version of reformulation behavior where reformulations can drop, replace, and/or add tokens. In this regard a TDR strategy may address an under-specification problem.

By way of example, a source query for “apple watch nike sport band vintage gothic shirts tight” employing a TD strategy may result in a hop-1 reformulation that drops the term “apple,” “band,” and “tight” and a hop-2 reformulation that drops the terms “apple,” “watch,” and “vintage.” In another example, a source query for “apple watch band official womens gothic clothing” employing a TDCR strategy may result in a hop-1 reformulation that replaces “official” with “nike” and “clothing” with “dresses” and a hop-2 reformulation that drops “official” and replaces “dresses” with “leggings.” In yet another example, a source query for “apple watch sport vintage gothic” employing a TDR strategy may result in a hop-1 reformulation that replaces “sport” with “nike” and adds “dress” and a hop-2 reformulation that adds “se” and “44,” drops “gothic,” and replaces “dress” with “gown.”

Fourth, in some aspects, diversity in reformulations, a valid reformulation capturing the user intent of q may be captured using a Jaccard-based metric. For example, a Jaccard similarity score may be defined by: is motivated by the ease of understanding. We use K grams (with K=3) based Jaccard similarity score defined as:

$$Jacc ( q 1 , q 2 ) = 3 grm ( q 1 ) ⋂ 3 grm ( q 2 ) / 3 grm ( q 1 ) ⋃ 3 grm ( q 2 )$$

where 3grm (q) is the consecutive set of 3-character words from all the tokens in q. A higher λ_{q1,q2} implies greater diversity in items retrieved between the two queries. In some aspects, items retrieved using t₁ and t₂ may come from multiple categories, indicating diversity in interpretations. For targets t₁, t₂ and model output r1, r2 the reformulation loss is minimized between the pairs t₁, r1 and t₂, r2, while maximizing the diversity loss between the pairs t₁, r2 and t₂, r1.

Using an NMT-based approach, the null and low query reformulations can be optimized. For reference, each instance in the training data is a triplet of [symbol] q, t₁, t₂ [symbol] ∈D and user reformulated queries in training data can be referred to as targets and model predictions as reformulations. Consider a source query q=q₁, . . . , qₖ, . . . , q_{M} consisting of M tokens, where qₖ represents the k^{th} token. The corresponding target queries: t1=t1₁, . . . , t1ⱼ_{₁}, . . . , t1_{N}_{₁} and t2=t2₁, . . . , t2ⱼ_{₂}, . . . , t2_{N}_{₂} model the target translation probabilities as:

$$ℙ ( ti \vert q ; θ ) = {\prod }_{{j}_{i} = 1}^{{N}_{i}} ℙ ( {ti}_{{j}_{i}} \vert q , {ti}_{< {j}_{i}} ; θ ) : i ∈ \{ 1 , 2 \}$$

where θ represents the model parameters and t1_{<j}_{ᵢ}=t1₁, . . . , t1ⱼ_{₁}₋₁ is a partial translated query. As discussed previously, it can be assumed that the translation probability of the hop-2 reformulation t2 is conditionally independent of the hop-1 transition t1 (i.e., [symbol] (t2|t1, q; θ)≈ [symbol] (t2|q; θ)). In other words, any reformulated query ri in the SRP burst for any null and low query q should have a high intent similarity with source query q irrespective of t1 while improving the performance of retrieved items in terms of recall and relevance.

A diversity loss [symbol] _{Div} component can be incorporated to maximize the diversity between the decoder predictions in conjunction with the traditional reformulation loss [symbol] _{Ref} component intended to minimize the error between the training targets and model predictions. For t1 and t2, r1 and r2 represent the corresponding predicted reformulations by the model. Assume [symbol] (ri, ti) may be a loss function to measure the disagreement between the model prediction ri and the training sample ti. For a given training dataset

$$D = {\{ 〈 {q}^{s} , t {1}^{s} , t {2}^{s} 〉 \}}_{s = 1}^{S} ,$$

the training objective is to minimize the total loss:

$$\hat{θ} = arg {min}_{θ} \{ ℒ ( θ ) \} s . t . ℒ ( θ ) = {ℒ}_{Ref} ( θ ) - α \cdot {ℒ}_{Div} ( θ )$$

$$where :$$

$${ℒ}_{Ref} ( θ ) = {\sum }_{s = 1}^{S} {\sum }_{i ∈ \{ 1 , 2 \}} ℓ ( {ri}^{s} , {ti}^{s} )$$

$${ℒ}_{Div} ( θ ) = {\sum }_{s = 1}^{S} {\sum }_{( i , j ) ∈ \{ ( 1 , 2 ) , ( 2 , 1 ) \}} ℓ ( {ri}^{s} , {tj}^{s} ) .$$

The effect of the seemingly adversarial component [symbol] _{Div} is controlled by α, which represented the intended diversity score. In aspects, a may be approximated from the training data such that α≈λₜᵣ. The training diversity score λₜᵣ may be leveraged to tune the reformulation diversity by the model. In aspects, the training diversity score can be defined as:

$${λ}_{tr} = 1 - \frac{1}{s} {\sum }_{s = 1}^{S} Jacc ( t {1}^{s} , t {2}^{s} ) .$$

In aspects, the domain-specific diversity score can be defined as per business needs. For example, various types of intent diversities may be recognized in the e-commerce domain such as: (i) categorical diversity: where the user targets correspond to items from different categories, and (ii) aspect diversity: where the user targets fetch items with different aspects/attributes.

Referring now to FIG. 2, an example system 200 is provided, in accordance with an aspect of the technology described herein. As shown in FIG. 2, the system 200 is a sequence-to-sequence model architecture comprising one encoder and two decoders (with a shared loss function). Each sample used in the training phase 210 consists of one source query and two user reformulation targets, and each decoder 230, 232 learns the user reformulation behavior for the corresponding target 222, 224. The loss function 230, as described herein, shared between the two decoders 230, 232 and aims to minimize reformulation error and maximize weighted diversity error. If a null and low query is encountered, the inference phase 280 is triggered. The encoder may receive the query 282 and generate various subword embeddings 284 to provide to the decoders 230, 240. Reformulated queries r1 260 and r2 270 are predicted for input query q 282. Each of the reformulated queries r1 260 and r2 270 may be used to fetch item recall set by the SE. For each dataset version, model parameters are learned and θ_{td}, θ_{tdcr}, and θ_{tdr} are the learned models on the training datasets TD, TDCR, and TDR, respectively.

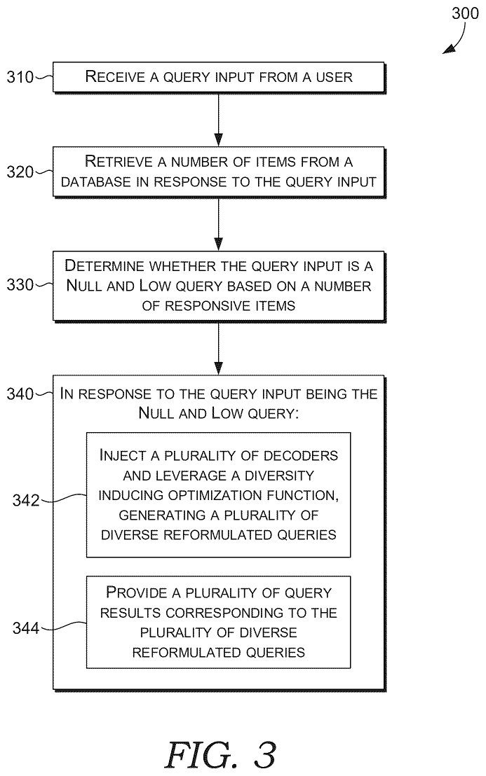

FIG. 3 is a flow diagram showing a method 300 for providing multiple reformulations for null and low queries, in accordance with an aspect of the technology described herein. The method 300 may be performed, for instance, by the search engine 108 of FIG. 1. As shown at block 310, a query input is initially received from a user. At block 320, a number of items is retrieved from a database in response to the query input.

At block 330, it is determined whether the query input is a null and low query based on the number of retrieved items. As described herein, a null and low query refers to refers to a search query that returns either no results (i.e., null) or a very small number of results (i.e., low) by a search engine. A null and low query indicates a lack of relevant information found based on the search criteria of the search query. In some aspects, a low query may be determined by a threshold configured by a user and/or automatically by the reformulation system.

At block 340, in response to the query input being the null and low query, a plurality of decoders is injected, as shown at block 342, in a sequence-to-sequence model and a diversity inducing optimization function is leveraged to generate a plurality of diverse reformulated queries. In some aspects, the sequence to sequence model is trained utilizing historical user data. The historical user data may comprise a historical search query and two historical user query reformulations (the historical user data may be stored in historical search logs). In some aspects, the historical user query reformulations may comprise one or more of dropped tokens, replaced tokens, or added tokens corresponding to the search query (for clarity, a token may refer to a portion of the search query such as a word). At block 344, a plurality of query results corresponding to the plurality of diverse reformulated queries is provided to the user.

In some aspects, the plurality of query results is provided to the user in a user interface without providing the plurality of diverse reformulated queries to the user. Alternatively, the plurality of query results and the plurality of diverse reformulated queries is provided to the user in a user interface. Each of the plurality of diverse reformulated queries and the corresponding plurality of query results may be separated within the user interface. For example, each reformulated query may have its own real estate or section within the user interface showing the corresponding plurality of query results.

With reference to FIG. 4, computing device 400 includes a bus 410 that directly or indirectly couples the following devices: memory 412, one or more processors 414, one or more presentation components 416, one or more input/output (I/O) ports 418, one or more I/O components 420, and an illustrative power supply 422. Bus 410 represents what may be one or more busses (such as an address bus, data bus, or combination thereof). Although the various blocks of FIG. 4 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 4 is merely illustrative of an exemplary computing device that can be used in connection with one or more aspects of the present technology. Distinction is not made between such categories as “workstation,” “server,” “laptop,” “handheld device,” etc., as all are contemplated within the scope of FIG. 4 and with reference to “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer-storage media and communication media.

Computer-storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 400. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 412 includes computer storage media in the form of volatile and/or nonvolatile memory. The memory may be removable, non-removable, or a combination thereof. Exemplary hardware devices include solid-state memory, hard drives, optical-disc drives, etc. Computing device 400 includes one or more processors 414 that read data from various entities such as memory 412 or I/O components 420. Presentation component(s) 416 presents data indications to a user or other device. Exemplary presentation components include a display device, speaker, printing component, vibrating component, and the like.

The I/O ports 418 allow computing device 400 to be logically coupled to other devices, including I/O components 420, some of which may be built in. Illustrative components include a microphone, joystick, game pad, satellite dish, scanner, printer, wireless device, etc.

The I/O components 420 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 400. The computing device 400 may be equipped with depth cameras, such as stereoscopic camera systems, infrared camera systems, RGB camera systems, and combinations of these, for gesture detection and recognition. Additionally, the computing device 400 may be equipped with accelerometers or gyroscopes that enable detection of motion. The output of the accelerometers or gyroscopes may be provided to the display of the computing device 400 to render immersive augmented reality or virtual reality.

Some aspects of computing device 400 may include one or more radio(s) 424 (or similar wireless communication components). The radio 424 transmits and receives radio or wireless communications. The computing device 400 may be a wireless terminal adapted to receive communications and media over various wireless networks. Computing device 400 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

What is claimed is:

1. A method comprising:
receiving a query input from a user;
retrieving a number of items from a database in response to the query input;
determining whether the query input is a null and low query based on the number of retrieved items;
in response to the query input being the null and low query:
injecting a plurality of decoders and leveraging a diversity inducing optimization function to generate a plurality of diverse reformulated queries;
providing, to the user, a plurality of query results corresponding to the plurality of diverse reformulated queries.

2. The method of claim 1, wherein the plurality of query results is provided to the user in a user interface without providing the plurality of diverse reformulated queries to the user.

3. The method of claim 1, wherein the plurality of query results and the plurality of diverse reformulated queries is provided to the user in a user interface.

4. The method of claim 3, further comprising separating each of the plurality of diverse reformulated queries and the corresponding plurality of query results within the user interface.

5. The method of claim 1, further comprising:
training a sequence-to-sequence model utilizing historical user data; and
injecting the plurality of decoders in the sequence-to-sequence model.

6. The method of claim 5, wherein the historical user data comprises a search query and two query reformulations.

7. The method of claim 6, wherein each of the two query reformulations comprise one or more of dropped tokens, replaced tokens, or added tokens corresponding to the search query.

8. One or more non-transitory computer storage media storing computer-readable instructions that when executed by a processor, cause the processor to perform operations, the operations comprising:
retrieving a number of items from a database in response to the query input;
determining whether the query input is a null and low query based on the number of retrieved items; and
in response to the query input being the null and low query:
reformulating the query input to generate a plurality of reformulated queries;
diversifying the reformulated queries to provide a plurality of diversified results; and
providing, to the user, the plurality of diversified results.

9. The media of claim 8, wherein the plurality of query results is provided to the user in a user interface without providing the plurality of diverse reformulated queries to the user.

10. The media of claim 8, wherein the plurality of query results and the plurality of diverse reformulated queries is provided to the user in a user interface.

11. The media of claim 10, further comprising separating each of the plurality of diverse reformulated queries and the corresponding plurality of query results within the user interface.

12. The media of claim 8, further comprising:
training the sequence-to-sequence model utilizing historical user data; and
utilizing the sequence-to-sequence model to perform the steps of reformulating the query input, diversifying the reformulated queries, and providing the plurality of diversified results.

13. The media of claim 12, wherein the historical user data comprises a search query and two query reformulations.

14. The media of claim 13, wherein each of the two query reformulations comprise one or more of dropped tokens, replaced tokens, or added tokens corresponding to the search query.

15. A system comprising:
at least one processor; and
one or more computer storage media storing computer-readable instructions that when executed by the at least one processor, cause the at least one processor to perform operations comprising:
retrieving a number of items from a database in response to the query input;
determining whether the query input is a null and low query based on the number of retrieved items;
in response to the query input being the null and low query:
injecting a plurality of decoders and leveraging a diversity inducing optimization function to generate a plurality of diverse reformulated queries;
providing, to the user, a plurality of query results corresponding to the plurality of diverse reformulated queries.

16. The system of claim 15, wherein the plurality of query results is provided to the user in a user interface without providing the plurality of diverse reformulated queries to the user.

17. The system of claim 15, wherein the plurality of query results and the plurality of diverse reformulated queries is provided to the user in a user interface.

18. The system of claim 17, further comprising separating each of the plurality of diverse reformulated queries and the corresponding plurality of query results within the user interface.

19. The system of claim 15, further comprising:
training a sequence-to-sequence model utilizing historical user data; and
injecting the plurality of decoders in the sequence-to-sequence model.

20. The system of claim 19, wherein the historical user data comprises a search query and two query reformulations, wherein each of the two query reformulations comprise one or more of dropped tokens, replaced tokens, or added tokens corresponding to the search query.
